(19) United States
(12) Patent Application Publication
(10) Pub. No.: US 2026/0333381 A1
(43) Pub. Date: Oct. 22, 2026

(54) REPORTING BASED ON DATA BLOCK TRANSMISSIONS FOR A HYBRID AUTOMATIC REPEAT REQUEST PROCESS

(71) Applicant: Lenovo (United States) Inc., Morrisville, NC (US)

(72) Inventors: Alexander Golitschek Edler von Elbwart, Darmstadt (DE); Joachim Löhr, Wiesbaden (DE)

(73) Assignee: Lenovo (United States) Inc., Morrisville, NC (US)

(21) Appl. No.: 19/389,976

(22) Filed: Nov. 14, 2025

(51) Int. Cl. H04W 72/232; H04L 1/1867

(52) U.S. Cl. CPC H04W 72/232; H04L 1/1896

(57) ABSTRACT

Various aspects of the present disclosure relate to reporting based on data block transmissions for a hybrid automatic repeat request (HARQ) process. An apparatus, such as a user equipment (UE), receives first downlink control information (DCI) indicating a transmission of a first data block (e.g., a previous data block) using a HARQ process. The UE receives second DCI indicating a transmission of a second data block (e.g., a new or current data block) using the HARQ process. In some cases, the transmission of the second data block is indicated to the UE (or detected by the UE irrespective of an erroneous reception of the first data block. In response to receiving the second DCI, the UE transmits a report indicative of potential packet loss.

### TECHNICAL FIELD

The present disclosure relates to wireless communications, and more specifically to reporting based on data block transmissions for a hybrid automatic repeat request (HARQ) process.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive first downlink control information (DCI) indicating a transmission of a first data block using a HARQ process; receive second DCI indicating a transmission of a second data block using the HARQ process, where the transmission of the second data block is indicated irrespective of an erroneous reception of the first data block; and transmit a report in response to receiving the second DCI.

A processor (e.g., a standalone processor chipset, or a component of a UE) for wireless communication is described. The processor may be configured to, capable of, or operable to perform one or more operations as described herein. For example, the processor may be configured to, capable of, or operable to receive first DCI indicating a transmission of a first data block using a HARQ process; receive second DCI indicating a transmission of a second data block using the HARQ process, where the transmission of the second data block is indicated irrespective of an erroneous reception of the first data block; and transmit a report in response to receiving the second DCI.

A method performed or performable by a UE for wireless communication is described. The method may include receiving first downlink control information (DCI) indicating a transmission of a first data block using a HARQ process; receiving second DCI indicating a transmission of a second data block using the HARQ process, where the transmission of the second data block is indicated irrespective of an erroneous reception of the first data block; and transmitting a report in response to receiving the second DCI.

In some implementations of the UE, the processor, and the method described herein, the report includes one or more of: a HARQ process identifier (ID) corresponding to the HARQ process associated with the transmissions of the first data block and the second data block; a new data indicator (NDI) associated with the second data block; an NDI associated with the first data block; a redundancy version (RV) of a last-received transmission of the first data block; an ID associated with the first data block, where the ID is a sequence number (SN), a radio link control (RLC) service data unit (SDU) ID, or a logical channel (LCH) ID; or a time of the transmission of the first data block.

In some implementations of the UE, the processor, and the method described herein, the second DCI includes an NDI associated with the second data block, and detecting the transmission of the second data block based on the NDI. In some implementations of the UE, the processor, and the method described herein, the UE, the processor, and the method may further be configured to, capable of, operable to, performed to, or performable to determine the erroneous reception of the first data block based on an error detection code associated with the first data block.

In some implementations of the UE, the processor, and the method described herein, the report is transmitted based on a HARQ buffer associated with the HARQ process being flushed. In some implementations of the UE, the processor, and the method described herein, the report is transmitted via a medium access control (MAC)-control element (MAC-CE), where the MAC-CE includes a respective report for each HARQ process for which transmission of a respective second data block is detected.

In some implementations of the UE, the processor, and the method described herein, for each HARQ process included in the MAC-CE, the MAC-CE includes a transport block (TB) field indicating for which TB of a plurality of TBs a report applies. In some implementations of the UE, the processor, and the method described herein, the report is transmitted via an uplink channel, where the report includes one or more of HARQ feedback for the transmission of the second data block, HARQ feedback for the transmission of the first data block or an indication of the erroneous reception of the first data block.

In some implementations of the UE, the processor, and the method described herein, the UE, the processor, and the method may further be configured to, capable of, operable to, performed to, or performable to receive a message indicating a new HARQ process ID to which the UE is to move HARQ buffer content associated with the first data block, where the report includes one or more of an indication that the HARQ buffer content is moved to the HARQ. In some implementations of the UE, the processor, and the method described herein, the report includes an NDI value that is used for a continued transmission of the first data block using the new HARQ process ID to which the HARQ buffer content is moved. In some implementations of the UE, the processor, and the method descried herein, the UE, the processor, and the method may further be configured to, capable of, operable to, performed to, or performable to receive a configuration that enables or disables moving the HARQ buffer content to the new HARQ process ID.

An NE (e.g., a base station) for wireless communication is described. The NE may be configured to, capable of, or operable to perform one or more operations as described herein. For example, the NE may be configured to, capable of, or operable to transmit first DCI indicating a transmission of a first data block using a HARQ process; transmit second DCI indicating a transmission of a second data block using the HARQ process; and receive a report in response to the transmission of the first data block and the transmission of the second data block.

A processor (e.g., a standalone processor chipset, or a component of a NE) for wireless communication is described. The processor may be configured to, capable of, or operable to perform one or more operations as described herein. For example, the processor may be configured to, capable of, or operable to transmit first DCI indicating a transmission of a first data block using a HARQ process; transmit second DCI indicating a transmission of a second data block using the HARQ process; and receive a report in response to the transmission of the first data block and the transmission of the second data block.

A method performed or performable by an NE (e.g., a base station) for wireless communication is described. The method may include transmitting first DCI indicating a transmission of a first data block using a HARQ process; transmitting second DCI indicating a transmission of a second data block using the HARQ process; and receiving a report in response to the transmission of the first data block and the transmission of the second data block.

In some implementations of the NE, the processor, and the method described herein, the report includes one or more of: a HARQ process ID corresponding to the HARQ process associated with the transmissions of the first data block and the second data block; an NDI associated with the second data block; an NDI associated with the first data block; an RV of a last-received transmission of the first data block; an ID associated with the first data block, where the ID is an SN, an RLC SDU ID, or an LCH ID; or a time of the transmission of the first data block.

In some implementations of the NE, the processor, and the method described herein, the second DCI includes an NDI associated with the second data block. In some implementations of the NE, the processor, and the method described herein, the report is received via a MAC-CE, where the MAC-CE includes a respective report for each HARQ process for which transmission of a respective second data block is detected.

In some implementations of the NE, the processor, and the method described herein, for each HARQ process included in the MAC-CE, the MAC-CE includes a TB field indicating for which TB of a plurality of TBs a report applies. In some implementations of the NE, the processor, and the method described herein, the report is received via an uplink channel, where the report includes one or more of HARQ feedback for the transmission of the second data block, HARQ feedback for the transmission of the first data block or an indication of the erroneous reception of the first data block.

In some implementations of the NE, the processor, and the method described herein, the NE, the processor, and the method may further be configured to, capable of, operable to, performed to, or performable to transmit a message indicating a new HARQ process ID to which a UE is to move HARQ buffer content associated with the first data block, where the report includes one or more of an indication that the HARQ buffer content is moved to the HARQ. In some implementations of the NE, the processor, and the method described herein, the report includes an NDI value that is used for a continued transmission of the first data block using the new HARQ process ID to which the HARQ buffer content is moved. In some implementations of the UE, the processor, and the method descried herein, the NE, the processor, and the method may further be configured to, capable of, operable to, performed to, or performable to transmit a configuration that enables or disables moving the HARQ buffer content to the new HARQ process ID.

### BRIEF DESCRIPTION OF THE DRAWINGS

FIG. 1 illustrates an example of a wireless communications system in accordance with aspects of the present disclosure.

FIGS. 2 and 3 illustrate examples of process flows in accordance with aspects of the present disclosure.

FIGS. 4 through 8 illustrate examples of MAC-CEs in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method performed by a UE in accordance with aspects of the present disclosure.

FIG. 13 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some cases, downlink and uplink data transmissions may utilize a number of HARQ processes for HARQ with incremental redundancy for retransmissions in case a UE erroneously (e.g., incorrectly) receives a TB. For downlink data transmission, the NE may expect the UE to transmit feedback (e.g., an ACK or a NACK) for each transmission and retransmission of a TB. In case of receiving NACK, the NE may continue performing scheduled transmission of the TB. Alternatively, if the NE receives an ACK, the NE may use the corresponding HARQ process for a new TB. The UE may be informed of a new TB by a toggled NDI in the DCI. The NDI is a bit field that informs the UE of whether a TB is a new TB or a retransmission of a previously transmitted TB. In the previous example, for a new TB, the NE toggles the NDI by updating the value of the NDI bit field in the DCI, for example, from “0” to “1”. Due to errors in the uplink transmission of the HARQ-ACK feedback, it is possible that a NACK is received as an ACK. In such cases, the NE may refrain from continuing with retransmissions for an incorrect packet (from the perspective of the UE), and therefore the corresponding packet will ultimately be missing at the UE, eventually triggering a higher layer retransmission (e.g., by the RLC layer). This incurs inefficiency and latency or, depending on the service in question, a loss of data.

Aspects of the present disclosure are described in the context of a wireless communications system, and include implementations that provide techniques for a UE to inform an NE of a request for a higher layer retransmission of one or more packets, such that the packets in question may be recovered earlier, avoiding excessive latency or packet loss. In one or more implementations, a UE may receive first DCI indicating a transmission of a first data block (e.g., a previous data block) using a HARQ process. The UE may receive second DCI indicating a transmission of a second data block (e.g., a new or current data block) using the HARQ process. In some cases, the transmission of the second data block may be indicated to the UE (or detected by the UE) irrespective of an erroneous reception of the first data block. As described herein, the first data block and the second data block may be one or more PDUs, SDUs, or other data or information.

In response to receiving the second DCI, the UE may transmit a report (e.g., a packet failure report) indicative of potential packet loss. By performing the described techniques, the UE and the NE in a wireless communications system can improve efficiency, reduce latency, and reduce data loss. For example, transmitting the report may inform the NE of potential packet loss as soon as it is detected by the UE, which may enable the NE to recover the packet sooner than if other signaling of packet loss were expected. Additionally, the report may be included in a MAC-CE or other uplink channel transmission, in some cases with other information (e.g., HARQ feedback), improving latency and signaling efficiency while reducing resource consumption.

Reference is made herein to communicating data or information, such as signaling communication resources and/or communications that are transmitted or received between devices.

It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

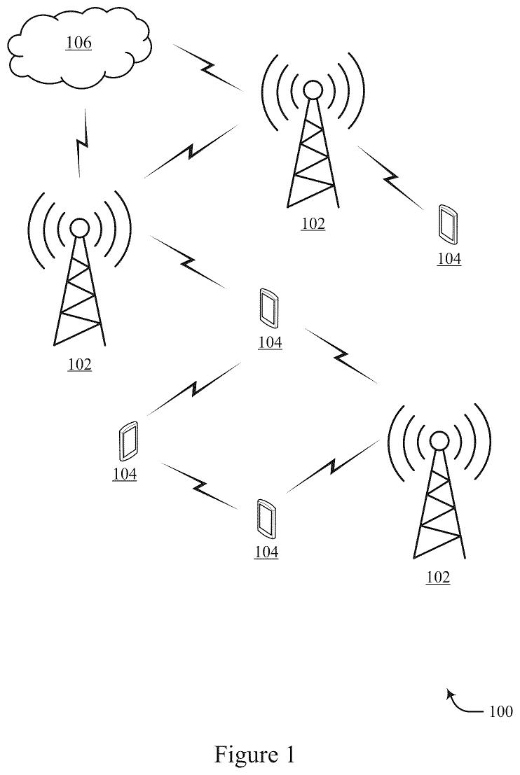

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a PDN over one or more backhaul links (e.g., via an S1, N2, N6, or other network interface). The PDN may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

To support particular communications, such as for extended reality (XR) use cases, the wireless communications system may support enhancements in the user plane. A packet data convergence protocol (PDCP) layer and an RLC layer in the user plane protocol stack may function independently from each other. On the receiving side (i.e., the UE side), the PDCP layer may maintain a reordering window to receive PDCP PDUs and transmit the PDUs to higher layers. At the RLC layer, a RLC receiving entity may maintain a reception window to receive RLC PDUs and transmit the RLC PDUs to higher layers. In the PDCP layer, the reordering window may be controlled by a timer (e.g., a t-Reordering timer) configured via radio resource control (RRC) signaling. When the timer expires, the reordering window may slide forward (i.e., a lower bound of the reordering window may be updated). If a packet is received outside of the shifted reordering window, the PDCP receiving entity may discard the packet.

In an RLC acknowledged mode (AM) mode, the receiving entity may slide (i.e., shift) its reception window when the lowest packet in the window (i.e., a packet with an SN that matches the lower bound of the RLC AM reception window) has been completely received and an ACK has been sent for the same. As the RLC and PDCP layers function independently, the reception window and the reordering window may be updated at different times. If the PDCP reordering window moves forward while the RLC window is left alone (i.e., not updated), the RLC layer may transmit packets to the PDCP layer that are outside of the reordering window, resulting in the discard of such packets. For example, the lower bounds of both a reordering window for the PDCP layer and a reception window in the RLC AM mode may expect a PDI with SN=0 (COUNT=0 in case of PDCP where COUNT=[hyper frame number (HFN), SN]). In some cases, the RLC receiving entity may correctly and fully receive some packets, including packets 0, 2, and 3, and transmit such packets to the PDCP layer. The PDCP layer may also receive the same packets 0, 2, and 3, missing packet 1. As such, the PDCP receiving entity may start the t-Reordering timer when the PDCP receiving entity receives packet 2 before packet 1, while the t-reassembly timer in the RLC layer may be started since one or more segments of the packet 1 are not yet received.

When the t-Reordering timer expires, the PDCP reordering window may update its lower bound to the next packet that has not been consecutively received. For example, packet 4 may be a next packet that has not been consecutively received after the t-Reordering timer expired. As such, the lower bound of the PDCP reordering window may be moved to packet 4, where in the RLC layer, the t-reassembly timer may trigger a status report based on expiry, and the reception window may not update unless the status report includes an ACK for packet 1. Since the RLC receiving entity has not received packet 1, the RLC receiving entity may still try to recover the packet by means of transmissions and retransmissions. When the RLC layer recovers the packet, the RLC layer may transmit the packet to the PDCP layer, and the PDCP layer may discard the packet because the PDCP layer received the packet outside of the reordering window. Such redundant transmissions are a waste of resources, and may add unwanted latency on the user plane.

Additionally, autonomous retransmissions may be enabled to enhance the RLC AM mode. That is, to achieve timely retransmissions on the RLC layer for XR traffic, the UE 104 may support autonomous retransmission (i.e., without a status report) of PDUs based on some triggers, retransmission based on enhanced status reporting, or retransmission based on enhanced polling. Such autonomous retransmissions may include retransmission triggered at an RLC transmitter without the transmitter receiving a status report (indicating a NACK) from its peer entity. However, autonomous retransmissions may quickly congest the link if the RLC transmits too many unnecessary autonomously retransmitted packets. This may further aggravate a delay encountered in the data transmission. Additionally, autonomous retransmissions may be redundant if triggered too early, such as before an initial transmission is received by the peer entity and/or if a packet has been ACKed but the RLC layer has not yet received the ACK. Such redundancy may lead to reduced throughput and resource waste. In addition, the MAC HARQ may also be simultaneously trying to recover and/or correctly decode a TB when an autonomous retransmission is triggered in the RLC layer. If the MAC HARQ is successful in decoding a TB including an RLC PDU that was also autonomously retransmitted, the autonomous retransmission may remain redundant, resulting in resource waste, reduced throughput, and increased latency.

Some RLC enhancements for ensuring timely RLC retransmissions include setting a poll bit for RLC PDUs based on one or more conditions, such as delay-criticality and autonomous RLC retransmission enhancements, which may be triggered proactively in the RLC transmission entity without receiving a status report. When applying such features in RLC, there may be a risk that the air interface is flooded with too many polls and/or too many unnecessary autonomous retransmissions, which may lead to congestion and delays on the link and reduction in system capacity. For example, when the remaining time of an RLC PDU (e.g., based on a discardTimer or discardTimerforLowImportance) falls below a threshold value, the RLC transmitter sets a poll bit in order to trigger a status report. If the delay-critical PDU is indicated as a NACK in a status report, the RLC transmitter may retransmit the packet. If the delay-critical PDU is indicated as an ACK, the RLC transmitter may discard the packet (e.g., following legacy procedures).

In some examples, the UE 104 may be configured with enhanced polling, autonomous retransmission, or both, allowing the RLC transmitter to perform legacy retransmissions and window updates (e.g., transmission window and reception window updates) based on the status reports. When enhanced polling, autonomous retransmission, or both are configured, the RLC transmitter may continue to perform retransmissions on top of the enhanced pools and autonomous retransmissions, which may cause additional delays on the link due to overflooding of packets. The MCS values of Table 1 may be supported for physical uplink shared channel (PUSCH) transmissions.

TABLE 1
MCS Indices for PUSCH Transmissions

| MCS | Modulation | Target Code | Spectral |
|---|---|---|---|
| Index I_{MCS} | Order Qₘ | Rate R x 1024 | Efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

According to implementations, one or more of the NEs 102 and the UEs 104 are operable to implement various aspects of the techniques described with reference to the present disclosure. For example, a UE 104 receives first DCI indicating a transmission of a first data block (e.g., a previous data block) using a HARQ process. The UE 104 receives second DCI indicating a transmission of a second data block (e.g., a new or current data block) using the HARQ process. In some cases, the transmission of the second data block may be indicated to the UE 104 (or detected by the UE 104 irrespective of an erroneous reception of the first data block. In response to receiving the second DCI, the UE 104 transmits a report indicative of potential packet loss, for example, via a MAC-CE.

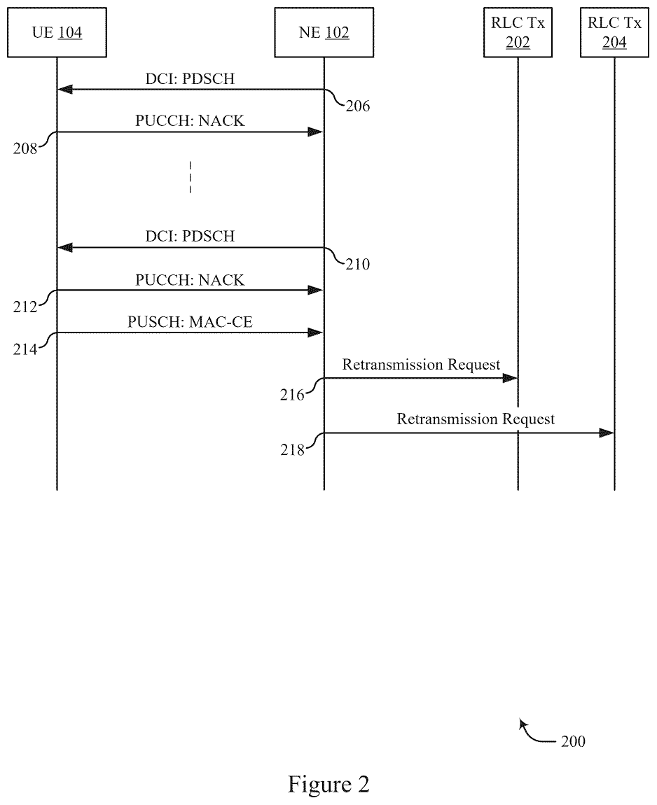

FIG. 2 illustrates an example of a process flow 200 in accordance with aspects of the present disclosure. The process flow 200 may be implemented in or supported by the wireless communications system 100. For example, the process flow 200 may be performed or enabled by a UE 104 and an NE 102, such as the UE 104 and the NE 102 described herein with reference to FIG. 1. The UE 104 may be an example of a HARQ receiver (HARQ Rx) and the NE 102 may be an example of a HARQ transmitter (Tx). Additionally, the process flow 200 may include communications between the UE 104 and the NE 102 with an RLC transmitter (Tx) 202 (e.g., an RLC transmitting entity), which may correspond to an LCH 1, and an RLC Tx 204, which may correspond to an LCH 2.

The process flow 200 supports a process by which the UE 104 may request, from the NE 102, a higher-layer ARQ retransmission, such as an RLC retransmission, of one or more RLC PDUs or RLC SDUs included in a TB, the TB transmitted on a PDSCH. In some implementations the UE 104 may transmit, on an uplink, a request for such higher-layer retransmissions of data included in a PDSCH that is currently being transmitted as part of an ongoing HARQ process. In some examples, the NE 102 may configure whether the UE 104 is allowed to request the local ARQ retransmission for a PDSCH transmission.

At 206, the UE 104 may receive, from the NE 102, a PDSCH transmission (e.g., indicated by DCI on physical downlink control channel (PDCCH) DCI) associated with a HARQ process. The PDSCH includes a TB with one or more RLC PDUs or RLC SDUs of one or more LCHs. For example, the PDSCH may include a PDU corresponding to an LCH 1, a PDU corresponding to an LCH 2, and so forth.

At 208, the UE 104 may transmit, to the NE 102, an uplink channel transmission (e.g., a physical uplink control channel (PUCCH) transmission) including HARQ feedback for the PDSCH. If the UE 104 is unable to successfully decode the PDUs/SDUs in the PDSCH, the UE 104 may include a NACK in the PUCCH.

At 210, the UE 104 may receive, from the NE 102, a retransmission of the PDSCH including the one or more PDUs/SDUs associated with respective LCHs (e.g., a PDU for LCH 1, a PDU for LCH 2). At 212, in response to unsuccessfully decoding the PDUs/SDUs in the PDSCH retransmission, the UE 104 may transmit, to the NE 102, a PUCCH including a NACK.

The UE 104 may determine that a probability of successfully decoding the PDSCH through further HARQ retransmissions is low, for example, based on LLRs associated with the received PDSCH. In such cases, as 214, the UE 104 may transmit an indication to abort further HARQ retransmissions for that PDSCH (e.g., a HARQ abort request), and a request for higher-layer (i.e., RLC) retransmissions of data included in the corresponding TB or PDSCH, such as the PDUs/SDUs. In some examples, initiating an RLC retransmission and updating link adaptation parameters (e.g., an MCS) for the higher-layer retransmission or scheduling the higher-layer retransmission on a different cell may yield improved performance compared to continuing HARQ retransmissions. This technique may be particularly advantageous when gain achieved by updated link adaptation exceed an expected HARQ soft-combining gain.

Based on receiving the HARQ abort request or the higher-layer retransmission request corresponding to a downlink TB or HARQ process, the NE 102 may terminate further HARQ retransmissions. Instead, the NE 102 may trigger fast (e.g., local) RLC retransmissions of the corresponding RLC PDUs/SDUs. In some implementations, a MAC entity in the NE 102 may indicate, to one or more relevant RLC entities, the retransmission request for the RLC PDUs/SDUs associated with the affected HARQ process. For example, at 216, the NE 102 may indicate, to the RLC Tx 202, a retransmission request for RLC PDUs/SDUs of the LCH 1. At 218, the NE 102 may indicate, to the RLC Tx 204, a retransmission request for RLC PDUs/SDUs of the LCH 2.

In some examples, the MAC entity of the NE 102 may maintain awareness of a mapping between the HARQ process and the RLC PDUs/SDUs delivered to the MAC layer during TB generation or LCH processing (LCP). In some implementations, the MAC layer may explicitly indicate SNs of the RLC PDUs/SDUs to be retransmitted, leveraging its knowledge of RLC header information. In some examples, the NE 102 may trigger the) transmission or retransmission of at least some of the MAC-CE(s) included in the PDSCH for which the HARQ abort request/higher layer retransmission request was received.

In some implementations, the UE 104 transmits the PUSCH including the higher-layer retransmission request via a MAC-CE. The MAC-CE may include a HARQ process ID field identifying the HARQ process for which the higher-layer retransmission is requested. Additionally, or alternatively, the MAC-CE may include timing-related information associated with the PDSCH. For example, the MAC-CE may include a slot index or a subframe index of the initial PDSCH transmission (i.e., at 206), or one of the HARQ retransmissions of the corresponding TB (i.e., at 210). HARQ process ID and the timing-related information included in the MAC-CE may uniquely identify the TB for which the UE 104 is requesting the higher-layer retransmission. In some implementations, the MAC-CE may include a higher layer retransmission request for multiple HARQ processes or multiple PDSCH transmissions (e.g., for the case where the MIMO transmission mode is used). In some implementations, in addition to one or more HARQ process ID fields, the MAC-CE may include an additional ID that unambiguously identifies the PDSCH transmission for which a higher layer retransmission is requested (e.g., a MIMO layer ID field).

In some examples, the MAC-CE may be associated with an SR configuration. In such cases, when the UE triggers a new MAC-CE but lacks available PUSCH resources, the UE 104 may initiate an SR procedure to obtain resources for transmission of the MAC-CE.

In some implementations, the UE 104 may transmit HARQ feedback for the PDSCH together with the MAC-CE (that requests the higher-layer retransmission) on the PUCCH. Transmitting the HARQ feedback in addition to the MAC-CE may allow the UE 104 to indicate that further HARQ retransmissions for the TB or PDSCH may be aborted (e.g., cancelled, discontinued) and replaced by the higher-layer retransmissions described herein. For example, the UE 104 may transmit HARQ-ACK feedback in addition to the MAC-CE, where the HARQ-ACK feedback ensures that the NE 102 refrains from scheduling additional HARQ retransmissions for the identified TB. Alternatively, the UE 104 may transmit HARQ-NACK feedback in addition to the MAC-CE, where the HARQ-NACK feedback may retrain TB information within a HARQ buffer of the NE 102. The HARQ-NACK feedback may signal to the NE 102 that the NE 102 may maintain access to the corresponding RLC PDUs for initiating a higher-layer retransmission. Alternatively, the UE 104 may transmit a DTX as HARQ feedback in addition to the MAC-CE, where the DTX indication may indicate a local ARQ retransmission request for the RLC PDUs or SDUs included in the TB or the PDSCH.

In some examples, the UE 104 may transmit the MAC-CE within a predefined or specified window after reception of the PDSCH. For example, the UE 104 may transmit the MAC-CE no later than a predefined time after the transmission of the corresponding HARQ feedback (e.g., on a PUCCH) for the PDSCH.

In some implementations, the UE 104 may transmit HARQ feedback for a PDSCH transmission in a TB on a PUSCH rather than transmitting UCI on a PUCCH or a PUSCH. In some cases, the UE 104 may transmit HARQ feedback via a MAC-CE. In addition to the HARQ feedback itself (i.e., an ACK or a NACK), the MAC-CE may include a HARQ process ID identifying the HARQ process that the HARQ feedback relates to. In some examples, the MAC-CE may indicate the higher-layer retransmission request as HARQ feedback. That is, the HARQ feedback may include any one of an ACK, a NACK, or the higher-layer retransmission request (e.g., an ARQ ReTx request). Alternatively, the UE 104 may directly indicate the higher-layer retransmission request via a PUCCH. For example, a third HARQ feedback state representing the higher-layer retransmission request may be introduced, which may allow the UE 104 to explicitly signal the request for the higher-layer retransmission through extended HARQ feedback signaling. For example, the HARQ feedback may indicate any one of an ACK, a NACK, or an ARQ ReTx Request.

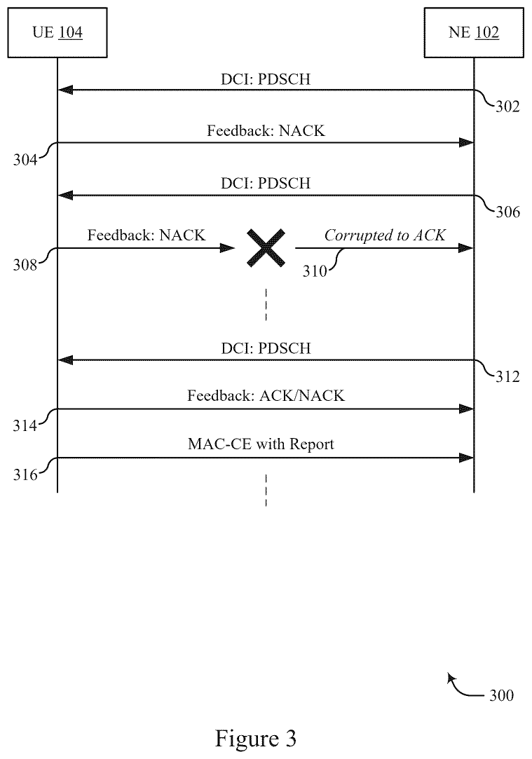

FIG. 3 illustrates an example of a process flow 300 in accordance with aspects of the present disclosure. The process flow 300 may be implemented in or supported by the wireless communications system 100. For example, the process flow 300 may be performed or enabled by a UE 104 and an NE 102, such as the UE 104 and the NE 102 described herein with reference to FIG. 1. The UE 104 may be an example of a HARQ Rx and the NE 102 may be an example of a HARQ Tx. The process flow 300 supports a process by which the UE 104 may transmit a report (e.g., a packet failure report) in response to receiving an indication for a transmission of a new data block even though the UE 104 failed to correctly receive a previous data block.

At 302, the UE 104 may receive, from the NE 102, first DCI indicating a transmission of a first data block using a HARQ process. The first data block may be referred to herein as a previous data block (i.e., a data block transmitted at an earlier time). In some examples, the UE 104 may receive the DCI via a PDCCH indicating a data block transmission on a PDSCH. At 304, based on failing to successfully decode the first data block, the UE 104 may transmit NACK feedback to the NE 102.

At 306, the UE may receive another DCI indicating a retransmission of the first data block using the same HARQ process. The UE 104 may detect the retransmission of the first data block based on receiving the other DCI.

At 308, as the retransmission of the first data block is indicated in the other DCI, the UE 104 may transmit NACK feedback to the NE 102. However, from the perspective of the NE 102, it may have appeared that the UE 104 received the first data block correctly. As such, at 310, the NACK feedback transmitted at 308 may be corrupted and the NE 102 may actually receive ACK feedback, which results in the NE 102 subsequently indicating a second data block via DCI at 312.

At 312, the UE 104 may receive, from the NE 102, a second DCI (e.g., via a PDCCH) indicating a new data block transmission on a PDSCH. The second data block may be referred to herein as a new data block or a current data block (i.e., a data block newly or most-recently received by the UE 104, or a data block being currently transmitted by the NE 102). The second data block may be a TB. In some cases, the second DCI may include a HARQ process ID corresponding to the HARQ process. The HARQ process ID may be used in context of a HARQ protocol for retransmissions of a data block. In some examples, the determination of the second data block may be facilitated by detecting a toggle of an NDI included in the second DCI, where the toggle may be determined with respect to a most recent previous DCI addressing the same HARQ process ID (e.g., the first DCI transmitted at 302 or a DCI indicating a retransmission at 306).

In some examples, the UE 104 may determine that the UE 104 has received an indication for the transmission of the second data block even if the UE 104 erroneously or incorrectly received the first data block. That is, the UE 104 may receive the second DCI at 312, which indicates the transmission of the second data block, despite the UE 104 erroneously receiving the first data block. In some examples, erroneous reception of the first data block may include a failure to decode the first data block, no reception of the first data block at all, or some other issue with reception of the first data block.

In some examples, the UE 104 may employ various techniques to determine (e.g., detect, identify) incorrect reception of the first data block. For example, an error detection code, such as a cyclic redundancy check (CRC) checksum included in the first data block to determine whether the first data block is correctly received. Additionally, or alternatively, the UE 104 may determine that it has not reported a positive ACK as feedback, including no feedback at all, for the transmission of the first data block. For example, the UE 104 may refrain from transmitting feedback for the first data block transmission if the UE 104 detects an incorrect reception of the first data block or by failure of conveying an ACK as feedback for the first data block (e.g., and instead, transmitting the NACK feedback at 308). This may be particularly applicable if the UE is expected (e.g., based on a configuration from the NE 102) to transmit HARQ feedback only in case of an incorrectly received data block, sometimes referred to as a “NACK-only” feedback mechanism. Alternatively, the UE 104 may determine the indication of the second data block transmission based on determining that a HARQ buffer for the HARQ process ID is flushed (e.g., emptied, cleared).

At 314, the UE 104 may transmit, to the NE 102, ACK feedback if the UE 104 correctly received the new data block transmission and NACK feedback if the UE 104 incorrectly received the new data block transmission.

At 316, if the UE 104 detects a new data block transmission (e.g., the second data block transmission or a subsequent new data block transmission) without having reported an ACK for the first data block transmission, the UE 104 may transmit generate and a report (e.g., a packet failure report) to the NE 102. The generation and transmission of the report at 312 may occur at any time after reception of the second DCI at 312 and more specifically, earlier, at a same time, or after the transmission of the feedback at 314. Additionally, or alternatively, the UE 104 may be triggered to transmit the report if the second data block transmission is indicated (e.g., if the UE 104 detects the second data block transmission) even though the UE 104 failed to correctly receive the first data block transmission. Additionally, or alternatively, the UE 104 may be triggered to transmit the report if a HARQ buffer associated with the HARQ process ID associated with the data block transmissions is flushed (e.g., emptied, cleared).

In some implementations, the report may include one or more of an indication of the HARQ process ID for which the UE 104 detected the second data block transmission indication, the NDI value corresponding to the second data block included in the second DCI, an NDI value received for a latest indication of the first data block transmission (e.g., corresponding to the first data block included in the first DCI), a redundancy version (RV) of the latest received transmission of the first data block, an ID associated with the first data block, such as an SN, an RLC SDU ID, or an LCH ID (e.g., which may be conveyed to the UE 104 by a PDCCH or DCI), or a time indication of a latest or first transmission time of the first data block transmission, such as a slot, subframe, or radio frame number, where the corresponding transmission has occurred or is scheduled to occur by DCI.

In some examples, the UE 104 may transmit the report via a MAC-CE. The MAC-CE may include multiple reports for multiple HARQ processes for which the UE 104 detects a new or current data block transmission. Additionally, or alternatively, the MAC-CE may include information for each relevant HARQ process ID. In such cases, for each HARQ process ID, the MAC-CE may include an indication (i.e., via an indicator) of whether or not the UE 104 has detected a new or current data block transmission.

In some examples, the UE 104 may transmit the report on a PUCCH or a PUSCH. In such cases, for a single report, the PUCCH or the PUSCH may include one or more of HARQ feedback (e.g., HARQ-ACK or HARQ-NACK) for the second (e.g., new or current) data block transmission, HARQ feedback (e.g., HARQ-ACK or HARQ-NACK) for the first (e.g., previous) data block transmission, an indication that the first data block transmission was not received correctly, or three-state feedback (i.e., a third state in addition to ACK and NACK).

In some implementations, the UE 104 may report one-bit HARQ-ACK feedback for a transmission if the transmission is determined to be a retransmission of a data block. The determination may be facilitated by detecting an untoggled NDI in the DCI scheduling the transmission compared to an indication of the most recent transmission using the same HARQ process. Additionally, or alternatively, the UE 104 may report a two-bit HARQ-ACK feedback for a transmission if the transmission is determined as a transmission of a second (i.e., new) data block. The determination may be facilitated by detecting a toggled NDI in the DCI scheduling the transmission compared to the indication of most recent transmission using the same HARQ process. The two-bit HARQ-ACK feedback may indicate one of the states from the UE's perspective depicted in Table 2.

TABLE 2
Two-Bit HARQ-ACK Feedback

| Two-bit HARQ- | Feedback for the | Feedback for the |
|---|---|---|
| ACK feedback | new/current data block | previous data block |
| 00 | NACK | NACK (i.e. the previous |
| | | data block was |
| | | not received correctly) |
| 01 | NACK | ACK (i.e. the previous |
| | | data block was |
| | | received correctly) |
| 10 | ACK | NACK (i.e. the previous |
| | | data block was |
| | | not received correctly) |
| 11 | ACK | ACK (i.e. the previous |
| | | data block was |
| | | received correctly) |

In some implementations, the UE 104 may report a one-bit HARQ-ACK feedback for a transmission if the transmission is determined as a transmission of a second (i.e., new) data block, where the UE 104 correctly received a first (i.e., previous) data block transmission. Alternatively, the UE 104 may report two-bit HARQ-ACK feedback for a transmission if the transmission is determined as a transmission of a second data block, where the UE 104 failed to correctly receive the first data block. The determination may be facilitated by detecting a toggled NDI in the DCI scheduling the transmission compared to the indication of most recent transmission using the same HARQ process. The two-bit HARQ-ACK feedback may indicate one of the states from the UE's perspective depicted in Table 3.

TABLE 3
Two-Bit HARQ-ACK Feedback

| HARQ-ACK | Feedback for the | Feedback for the |
|---|---|---|
| feedback | new/current data block | previous data block |
| 0 | NACK | N/A (DTX, implicit ACK) |
| 1 | ACK | N/A (DTX, implicit ACK) |
| 00 | NACK | NACK (i.e. the previous |
| | | data block was |
| | | not received correctly) |
| 10 | ACK | NACK (i.e. the previous |
| | | data block was |
| | | not received correctly) |

In some implementations, the UE 104 may move HARQ buffer content for a data block which the UE 104 has received incorrectly (e.g., the first, previous data block) correctly to a vacant or new HARQ process ID, if available. The NE 102 may use the new HARQ process ID to continue with further retransmissions of a packet (instead of simply overwriting the HARQ buffer for a second, new data block). In some cases, the report may include an indicator that the HARQ buffer content has been moved. Additionally, or alternatively, the report may include the new HARQ process ID to which the UE 104 moves the HARQ buffer content. Additionally, or alternatively, the UE 104 may receive, from the NE 102, a configuration including a new HARQ process ID to which the UE 104 moves the HARQ buffer content. In such cases, the report may be transmitted without the new HARQ process ID and instead include an on/off indication in the report to indicate whether or not the UE 104 has moved the HARQ buffer content to the new HARQ process ID.

Additionally, or alternatively, the report may include an NDI value, which the UE 104 may expect to be used for a continued transmission of the first data packet using the new HARQ process ID to which the UE 104 moves the HARQ buffer content. The indicated NDI value may be used in a subsequent DCI to continue the first data block transmission with the new HARQ process ID. Additionally, or alternatively, the UE 104 receives, from the NE 102, a configuration that enables or disables moving of the HARQ buffer content associated with the first data block. For example, if the configuration is enabling, the UE 104 may move the HARQ buffer content to the new HARQ process ID. The NE 102 may transmit the configuration via one or more of a MAC-CE, an uplink control channel (e.g., a PUCCH), or an uplink shared channel (e.g., a PUSCH). Additionally, or alternatively, the UE 104 may receive the new HARQ process ID to which the HARQ buffer content is moved, for example, by an RRC configuration. In such cases, if the new HARQ process ID is configured, the UE 104 may refrain from including an indication of the new HARQ process ID in the report. In this way, the NE 102 may effectively overrides or controls whether the HARQ process ID is used for a particular data block. For example, if the NE 102 uses the new HARQ process ID to continue the first data block transmission, the NDI included in the report may be indicated by a subsequent DCI indicting continued transmission of the first data block. If not (e.g., if the NE 102 intends to use the new HARQ process ID for a new TB or data block), the subsequent DCI may indicate a NDI having a different value than the NDI included in the report.

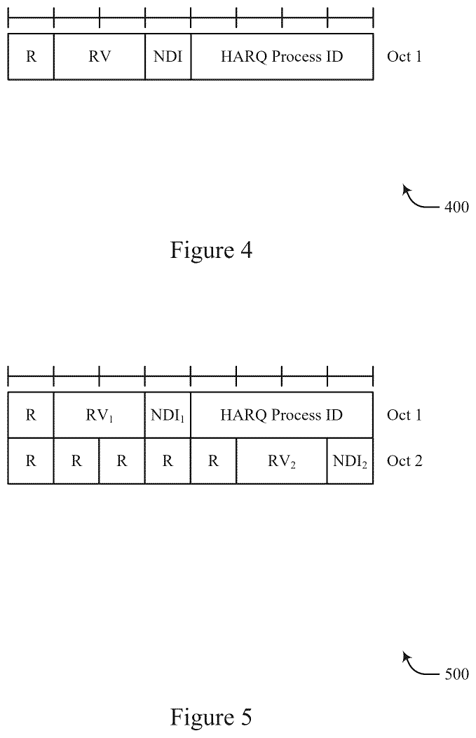

FIG. 4 illustrates an example of a MAC-CE 400 in accordance with aspects of the present disclosure. In this example, the MAC-CE 400 may be implemented in or supported by the wireless communications system 100 described herein with reference to FIG. 1, and the process flow 300 described herein with reference to FIG. 3. For example, a UE 104 may transmit the MAC-CE 400 to indicate a report (e.g., a packet failure report) when the UE 104 receives DCI indicating a new data block transmission despite the UE 104 failing to correctly receive a previous data block transmission.

The MAC-CE 400 may carry a report for a single data block transmission. In the example of FIG. 4, the MAC-CE 400 may include one octet (e.g., Oct 1) including four bits indicating a HARQ process ID, one bit indicating an NDI value of a previous data block, two bits indicating a latest received RV of the previous data block, and one reserved bit.

FIG. 5 illustrates an example of a MAC-CE 500 in accordance with aspects of the present disclosure. In this example, the MAC-CE 500 may be implemented in or supported by the wireless communications system 100 described herein with reference to FIG. 1, and the process flow 300 described herein with reference to FIG. 3. For example, a UE 104 may transmit the MAC-CE 500 to indicate a report (e.g., a packet failure report) when the UE 104 receives DCI indicating a new data block transmission despite the UE 104 failing to correctly receive a previous data block transmission.

The MAC-CE 500 may carry a report for a two data block transmissions using a same HARQ process (e.g., a multiple-input multiple-output (MIMO) case). In the example of FIG. 5, the MAC-CE 500 may include two octets, a first octet (e.g., Oct 1) including four bits indicating a HARQ process ID, one bit indicating an NDI value of a first corresponding previous data block (e.g., NDI₁), two bits indicating a latest received RV of the first corresponding previous data block (e.g., RV₁), and one reserved bit, and a second octet (e.g., Oct 2) including one bit indicating an NDI value of a second corresponding previous data block (e.g., NDI₂), two bits indicating a latest received RV of the second corresponding previous data block (e.g., RV₂), and five reserved bits to fill the octet.

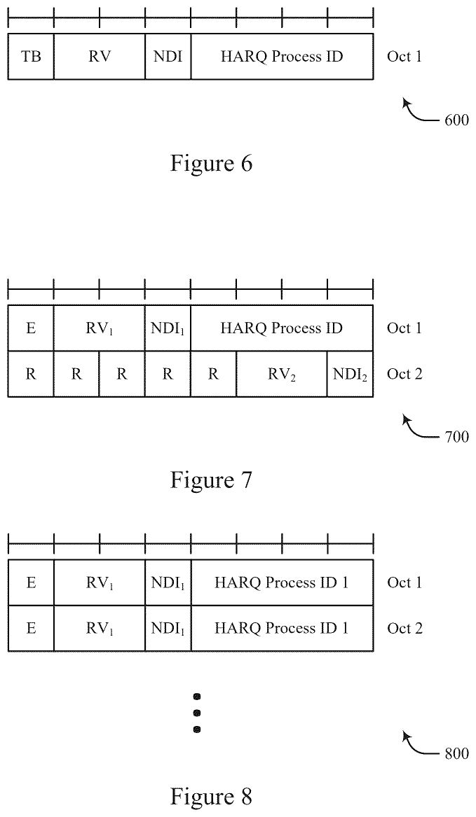

FIG. 6 illustrates an example of a MAC-CE 600 in accordance with aspects of the present disclosure. In this example, the MAC-CE 600 may be implemented in or supported by the wireless communications system 100 described herein with reference to FIG. 1, and the process flow 300 described herein with reference to FIG. 3. For example, a UE 104 may transmit the MAC-CE 600 to indicate a report (e.g., a packet failure report) when the UE 104 receives DCI indicating a new data block transmission despite the UE 104 failing to correctly receive a previous data block transmission.

The MAC-CE 600 may carry a report for a single data block transmission. In the example of FIG. 6, the MAC-CE 600 may include one octet (e.g., Oct 1) with a one-bit TB field to indicate for which TB of a set of TBs the report applies. For example, if there are two TBs, the one-bit TB field may indicate the report information for a first TB by setting a value of the TB field to “0” or for a second TB by setting the value of the TB field to “1.” The MAC-CE 600 may also include four bits indicating a HARQ process ID, one bit indicating an NDI value of a previous data block, and two bits indicating a latest received RV of the previous data block.

FIG. 7 illustrates an example of a MAC-CE 700 in accordance with aspects of the present disclosure. In this example, the MAC-CE 700 may be implemented in or supported by the wireless communications system 100 described herein with reference to FIG. 1, and the process flow 300 described herein with reference to FIG. 3. For example, a UE 104 may transmit the MAC-CE 700 to indicate a report (e.g., a packet failure report) when the UE 104 receives DCI indicating a new data block transmission despite the UE 104 failing to correctly receive a previous data block transmission.

The MAC-CE 700 may carry a report for a two data block transmissions using a same HARQ process (e.g., a MIMO case). In the example of FIG. 7, the MAC-CE 700 may include two octets, a first octet (e.g., Oct 1) including four bits indicating a HARQ process ID, one bit indicating an NDI value of a first corresponding previous data block (e.g., NDI₁), two bits indicating a latest received RV of the first corresponding previous data block (e.g., RV₁), and a one-bit extension flag, “E.” When set to a first value, the MAC-CE 700 may be extended to include information for at least a second data block using the same HARQ process ID. This may be particularly applicable for MIMO transmissions supporting the transmission of two or more TBs at the same time. Corresponding information may include, in a second octet (e.g., Oct 2), one bit indicating an NDI value of the second data block (e.g., NDI₂), two bits indicating a latest received RV of the second data block (e.g., RV₂), and five reserved bits to fill the octet. This may further imply that a second octet is available in the MAC-CE 700.

FIG. 8 illustrates an example of a MAC-CE 800 in accordance with aspects of the present disclosure. In this example, the MAC-CE 800 may be implemented in or supported by the wireless communications system 100 described herein with reference to FIG. 1, and the process flow 300 described herein with reference to FIG. 3. For example, a UE 104 may transmit the MAC-CE 800 to indicate a report (e.g., a packet failure report) when the UE 104 receives DCI indicating a new data block transmission despite the UE 104 failing to correctly receive a previous data block transmission.

The MAC-CE 800 may carry a report for a two data block transmissions allowing for different HARQ processes (e.g., a MIMO case). In the example of FIG. 8, the MAC-CE 800 may include two octets, a first octet (e.g., Oct 1) including four bits indicating a HARQ process ID for a first data block (e.g., HARQ Process ID 1), one bit indicating an NDI value of the first data block (e.g., NDI₁), two bits indicating a latest received RV of the first data block (e.g., RV₁), and a one-bit extension flag (e.g., E₁). That is, when set to a first value, the MAC-CE 800 may be extended to include information for at least a second data block using the same HARQ process ID. This may be particularly applicable for multi-TB transmissions over more than one time unit indicated by a same DCI. Corresponding information may therefore include, in a second octet (e.g., Oct 2), four bits indicating a HARQ process ID for a second data block (e.g., HARQ Process ID 2), one bit indicating an NDI value of the second data block (e.g., NDI₂), two bits indicating a latest received RV of the second data block (e.g., RV₂), and a one-bit extension flag (e.g., E₂), further implying that the second octet is available in the MAC-CE 800. The extension flag in the first octet, E₁, being set to a value of “1” may indicate that a second report is included in the MAC-CE 800 for the second data block (e.g., including the HARQ Process ID 2, the NDI₂, and the RV₂. The extension flag in the second octet, E₂, being set to ‘0’ may indicate that no additional reports are included in the MAC-CE 800, implying that the MAC-CE 800 includes no more than the two octets.

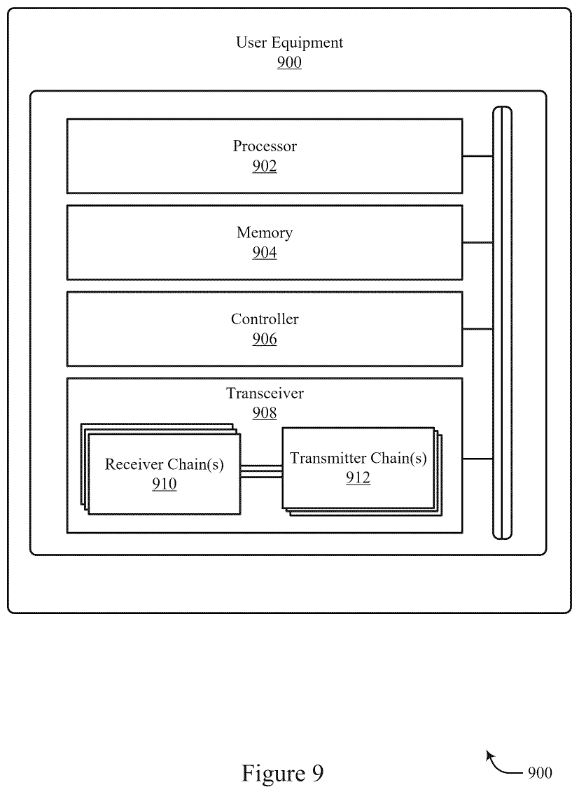

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for receiving first DCI indicating a transmission of a first data block using a HARQ process; receiving second DCI indicating a transmission of a second data block using the HARQ process, where the transmission of the second data block is indicated irrespective of an erroneous reception of the first data block; and transmitting a report in response to receiving the second DCI. In this manner, the UE 900 supports reporting based on data block transmissions for a HARQ process, which improves efficiency, reduces latency, and reduces data loss as an NE is quickly informed of potential packet loss.

Additionally, the UE 900 may be configured to support any one or combination of the following. For example, the UE 900 may be configured to support where the report includes one or more of: a HARQ process ID corresponding to the HARQ process associated with the transmissions of the first data block and the second data block; an NDI associated with the second data block; an NDI associated with the first data block; an RV of a last-received transmission of the first data block; an ID associated with the first data block, where the ID is an SN; an RLC SDU ID, or an LCH ID; or a time of the transmission of the first data block. This aspect ensures that the UE accurately and efficiently reports which packets the UE failed to receive such that the NE may recover the packet.

Additionally, or alternatively, the UE 900 may be configured to support where the second DCI includes an NDI associated with the second data block, and detecting the transmission of the second data block based on the NDI. This aspect ensures efficiency and limits resource and signaling overhead as the UE is able to detect the transmission of the second data block from received DCI instead of another separate indication.

Additionally, or alternatively, the UE 900 may be configured to support determining the erroneous reception of the first data block based on an error detection code associated with the first data block. This aspect ensures accuracy of the determination as the UE performs some error detection procedure.

Additionally, or alternatively, the UE 900 may be configured to support where the report is transmitted based on a HARQ buffer associated with the HARQ process being flushed. This aspect ensures accuracy of the determination that the transmission of the first data block is received incorrectly by enabling the UE to detect incorrect reception of the first data block transmission based on the HARQ buffer in addition to signaling.

Additionally, or alternatively, the UE 900 may be configured to support where the report is transmitted via a MAC-CE, where the MAC-CE includes a respective report for each HARQ process for which transmission of a respective second data block is detected. This aspect ensures efficiency and simplicity by employing existing capabilities of MAC-CEs for transmission of the retransmission request.

Additionally, or alternatively, the UE 900 may be configured to support where, for each HARQ process included in the MAC-CE, the MAC-CE includes a TB field indicating for which TB of a plurality of TBs a report applies. This aspect ensures efficiency and simplicity by employing existing capabilities of MAC-CEs for transmission of the retransmission request.

Additionally, or alternatively, the UE 900 may be configured to support where the report is transmitted via an uplink channel, where the report includes one or more of HARQ feedback for the transmission of the second data block, HARQ feedback for the transmission of the first data block or an indication of the erroneous reception of the first data block. This aspect ensures resource and signaling efficiency by combining the report and HARQ feedback in a same transmission.

Additionally, or alternatively, the UE 900 may be configured to support where receiving a message indicating a new HARQ process ID to which the UE is to move HARQ buffer content associated with the first data block, where the report includes one or more of an indication that the HARQ buffer content is moved to the HARQ. This aspect ensures resource and signaling efficiency by combining the report and HARQ feedback in a same transmission.

Additionally, or alternatively, the UE 900 may be configured to support where the report includes an NDI value that is used for a continued transmission of the first data block using the new HARQ process ID to which the HARQ buffer content is moved. This aspect ensures the transmitted report is associated with the correct data block transmission. Additionally, or alternatively, the UE 900 may be configured to support receiving a configuration that enables or disables moving the HARQ buffer content to the new HARQ process ID. This aspect improves efficiency by ensuring the UE and the NE are aware of the use of the new HARQ process ID.

Additionally, or alternatively, the UE 900 may support at least one memory (e.g., the memory 904) and at least one processor (e.g., the processor 902) coupled with the at least one memory and configured to cause the UE to receive first DCI indicating a transmission of a first data block using a HARQ process; receive second DCI indicating a transmission of a second data block using the HARQ process, where the transmission of the second data block is indicated irrespective of an erroneous reception of the first data block; and transmit a report in response to receiving the second DCI. In this manner, the UE 900 supports reporting based on data block transmissions for a HARQ process, which improves efficiency, reduces latency, and reduces data loss as an NE is quickly informed of potential packet loss.

Additionally, the UE 900 may be configured to support any one or combination of the following. For example, the UE 900 may be configured to support where the report includes one or more of: a HARQ process ID corresponding to the HARQ process associated with the transmissions of the first data block and the second data block; an NDI associated with the second data block; an NDI associated with the first data block; an RV of a last-received transmission of the first data block; an ID associated with the first data block, where the ID is an SN; an RLC SDU ID, or an LCH ID; or a time of the transmission of the first data block. This aspect ensures that the UE accurately and efficiently reports which packets the UE failed to receive such that the NE may recover the packet.

Additionally, or alternatively, the UE 900 may be configured to support where the second DCI includes an NDI associated with the second data block, and detecting the transmission of the second data block based on the NDI. This aspect ensures efficiency and limits resource and signaling overhead as the UE is able to detect the transmission of the second data block from received DCI instead of another separate indication.

Additionally, or alternatively, the UE 900 may be configured to support determining the erroneous reception of the first data block based on an error detection code associated with the first data block. This aspect ensures accuracy of the determination as the UE performs some error detection procedure.

Additionally, or alternatively, the UE 900 may be configured to support where the report is transmitted based on a HARQ buffer associated with the HARQ process being flushed. This aspect ensures accuracy of the determination that the transmission of the first data block is received incorrectly by enabling the UE to detect incorrect reception of the first data block transmission based on the HARQ buffer in addition to signaling.

Additionally, or alternatively, the UE 900 may be configured to support where the report is transmitted via a MAC-CE, where the MAC-CE includes a respective report for each HARQ process for which transmission of a respective second data block is detected. This aspect ensures efficiency and simplicity by employing existing capabilities of MAC-CEs for transmission of the retransmission request.

Additionally, or alternatively, the UE 900 may be configured to support where, for each HARQ process included in the MAC-CE, the MAC-CE includes a TB field indicating for which TB of a plurality of TBs a report applies. This aspect ensures efficiency and simplicity by employing existing capabilities of MAC-CEs for transmission of the retransmission request.

Additionally, or alternatively, the UE 900 may be configured to support where the report is transmitted via an uplink channel, where the report includes one or more of HARQ feedback for the transmission of the second data block, HARQ feedback for the transmission of the first data block or an indication of the erroneous reception of the first data block. This aspect ensures resource and signaling efficiency by combining the report and HARQ feedback in a same transmission.

Additionally, or alternatively, the UE 900 may be configured to support receiving a message indicating a new HARQ process ID to which the UE is to move HARQ buffer content associated with the first data block, where the report includes one or more of an indication that the HARQ buffer content is moved to the HARQ. This aspect ensures resource and signaling efficiency by combining the report and HARQ feedback in a same transmission.

Additionally, or alternatively, the UE 900 may be configured to support where the report includes an NDI value that is used for a continued transmission of the first data block using the new HARQ process ID to which the HARQ buffer content is moved. This aspect ensures the transmitted report is associated with the correct data block transmission. Additionally, or alternatively, the UE 900 may be configured to support receiving a configuration that enables or disables moving the HARQ buffer content to the new HARQ process ID. This aspect improves efficiency by ensuring the UE and the NE are aware of the use of the new HARQ process ID.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

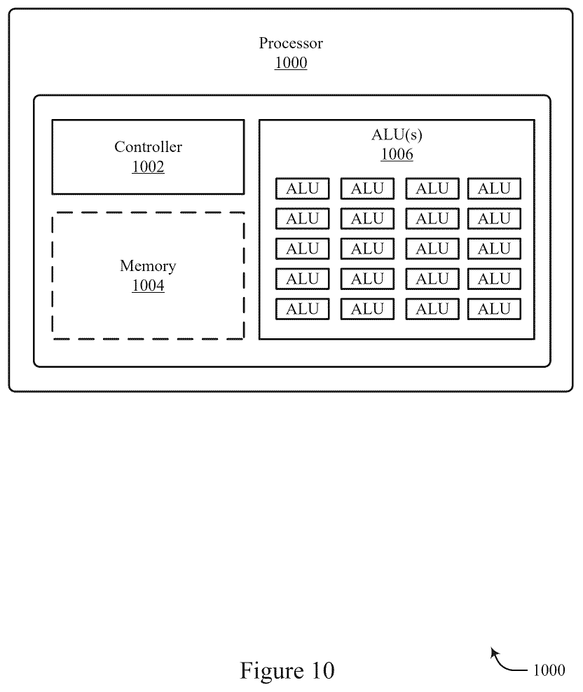

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to receive first DCI indicating a transmission of a first data block using a HARQ process; receive second DCI indicating a transmission of a second data block using the HARQ process, where the transmission of the second data block is indicated irrespective of an erroneous reception of the first data block; and transmit a report in response to receiving the second DCI. In this manner, the processor 1000 supports reporting based on data block transmissions for a HARQ process, which improves efficiency, reduces latency, and reduces data loss as an NE is quickly informed of potential packet loss.

Additionally, the processor 1000 may be configured to support any one or combination of the following. For example, the processor 1000 may be configured to support where the report includes one or more of: a HARQ process ID corresponding to the HARQ process associated with the transmissions of the first data block and the second data block; an NDI associated with the second data block; an NDI associated with the first data block; an RV of a last-received transmission of the first data block; an ID associated with the first data block, where the ID is an SN; an RLC SDU ID, or an LCH ID; or a time of the transmission of the first data block. This aspect ensures that the UE accurately and efficiently reports which packets the UE failed to receive such that the NE may recover the packet.

Additionally, or alternatively, the processor 1000 may be configured to support where the second DCI includes an NDI associated with the second data block, and detecting the transmission of the second data block based on the NDI. This aspect ensures efficiency and limits resource and signaling overhead as the UE is able to detect the transmission of the second data block from received DCI instead of another separate indication.

Additionally, or alternatively, the processor 1000 may be configured to support determining the erroneous reception of the first data block based on an error detection code associated with the first data block. This aspect ensures accuracy of the determination as the UE performs some error detection procedure.

Additionally, or alternatively, the processor 1000 may be configured to support where the report is transmitted based on a HARQ buffer associated with the HARQ process being flushed. This aspect ensures accuracy of the determination that the transmission of the first data block is received incorrectly by enabling the UE to detect incorrect reception of the first data block transmission based on the HARQ buffer in addition to signaling.

Additionally, or alternatively, the processor 1000 may be configured to support where the report is transmitted via a MAC-CE, where the MAC-CE includes a respective report for each HARQ process for which transmission of a respective second data block is detected. This aspect ensures efficiency and simplicity by employing existing capabilities of MAC-CEs for transmission of the retransmission request.

Additionally, or alternatively, the processor 1000 may be configured to support where, for each HARQ process included in the MAC-CE, the MAC-CE includes a TB field indicating for which TB of a plurality of TBs a report applies. This aspect ensures efficiency and simplicity by employing existing capabilities of MAC-CEs for transmission of the retransmission request.

Additionally, or alternatively, the processor 1000 may be configured to support where the report is transmitted via an uplink channel, where the report includes one or more of HARQ feedback for the transmission of the second data block, HARQ feedback for the transmission of the first data block or an indication of the erroneous reception of the first data block. This aspect ensures resource and signaling efficiency by combining the report and HARQ feedback in a same transmission.

Additionally, or alternatively, the processor 1000 may be configured to support receiving a message indicating a new HARQ process ID to which the UE is to move HARQ buffer content associated with the first data block, where the report includes one or more of an indication that the HARQ buffer content is moved to the HARQ. This aspect ensures resource and signaling efficiency by combining the report and HARQ feedback in a same transmission.

Additionally, or alternatively, the processor 1000 may be configured to support where the report includes an NDI value that is used for a continued transmission of the first data block using the new HARQ process ID to which the HARQ buffer content is moved. This aspect ensures the transmitted report is associated with the correct data block transmission. Additionally, or alternatively, the processor 1000 may be configured to support receiving a configuration that enables or disables moving the HARQ buffer content to the new HARQ process ID. This aspect improves efficiency by ensuring the UE and the NE are aware of the use of the new HARQ process ID.

Additionally, or alternatively, the processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to transmit first DCI indicating a transmission of a first data block using a HARQ process; transmit second DCI indicating a transmission of a second data block using the HARQ process; and receive a report in response to the transmission of the first data block and the transmission of the second data block. In this manner, the processor 1000 supports reporting based on data block transmissions for a HARQ process, which improves efficiency, reduces latency, and reduces data loss as an NE is quickly informed of potential packet loss.

Additionally, or alternatively, the processor 1000 may be configured to support any one or combination of the following. For example, the processor 1000 may be configured to support where the report includes one or more of: a HARQ process ID corresponding to the HARQ process associated with the transmissions of the first data block and the second data block; an NDI associated with the second data block; an NDI associated with the first data block; an RV of a last-received transmission of the first data block; an ID associated with the first data block, where the ID is an SN, an RLC SDU ID, or an LCH ID; or a time of the transmission of the first data block. This aspect ensures that the UE accurately and efficiently reports which packets the UE failed to receive such that the NE may recover the packet.

Additionally, or alternatively, the processor 1000 may be configured to support where the second DCI includes an NDI associated with the second data block. This aspect ensures efficiency and limits resource and signaling overhead as the UE is able to detect the transmission of the second data block from received DCI instead of another separate indication.

Additionally, or alternatively, the processor 1000 may be configured to support where the report is received via a MAC-CE, where the MAC-CE includes a respective report for each HARQ process for which transmission of a respective second data block is detected. This aspect ensures efficiency and simplicity by employing existing capabilities of MAC-CEs for transmission of the retransmission request.

Additionally, or alternatively, the processor 1000 may be configured to support where, for each HARQ process included in the MAC-CE, the MAC-CE includes a TB field indicating for which TB of a plurality of TBs a report applies. This aspect ensures efficiency and simplicity by employing existing capabilities of MAC-CEs for transmission of the retransmission request.

Additionally, or alternatively, the processor 1000 may be configured to support where the report is received via an uplink channel, where the report includes one or more of HARQ feedback for the transmission of the second data block, HARQ feedback for the transmission of the first data block or an indication of the erroneous reception of the first data block. This aspect ensures resource and signaling efficiency by combining the report and HARQ feedback in a same transmission.

Additionally, or alternatively, the processor 1000 may be configured to support transmitting a message indicating a new HARQ process ID to which a UE is to move HARQ buffer content associated with the first data block, where the report includes one or more of an indication that the HARQ buffer content is moved to the HARQ. This aspect ensures resource and signaling efficiency by combining the report and HARQ feedback in a same transmission.

Additionally, or alternatively, the processor 1000 may be configured to support where the report includes an NDI value that is used for a continued transmission of the first data block using the new HARQ process ID to which the HARQ buffer content is moved. This aspect ensures the transmitted report is associated with the correct data block transmission. Additionally, or alternatively, the processor 1000 may be configured to support transmitting a configuration that enables or disables moving the HARQ buffer content to the new HARQ process ID. This aspect improves efficiency by ensuring the UE and the NE are aware of the use of the new HARQ process ID.

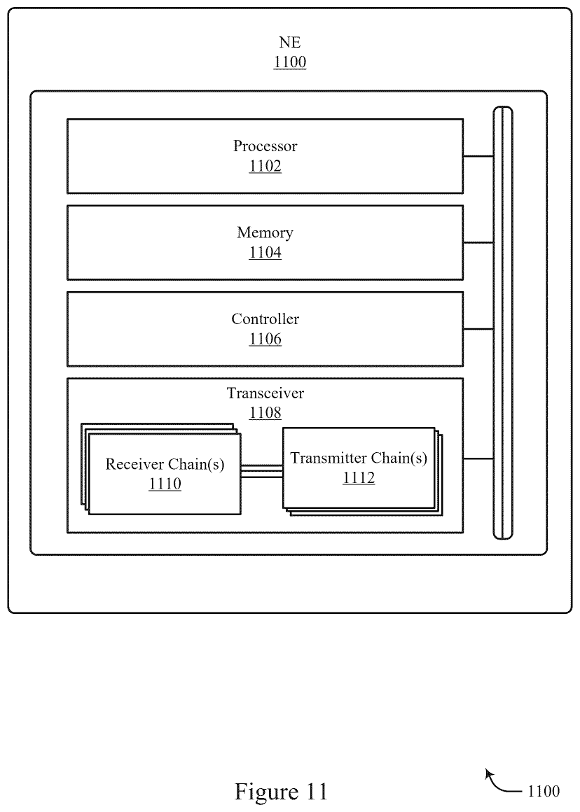

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for transmitting first DCI indicating a transmission of a first data block using a HARQ process; transmitting second DCI indicating a transmission of a second data block using the HARQ process; and receiving a report in response to the transmission of the first data block and the transmission of the second data block. In this manner, the NE 1100 supports reporting based on data block transmissions for a HARQ process, which improves efficiency, reduces latency, and reduces data loss as an NE is quickly informed of potential packet loss.

Additionally, or alternatively, the NE 1100 may be configured to support any one or combination of the following. For example, the NE 1100 may be configured to support where the report includes one or more of: a HARQ process ID corresponding to the HARQ process associated with the transmissions of the first data block and the second data block; an NDI associated with the second data block; an NDI associated with the first data block; an RV of a last-received transmission of the first data block; an ID associated with the first data block, where the ID is an SN, an RLC SDU ID, or an LCH ID; or a time of the transmission of the first data block. This aspect ensures that the UE accurately and efficiently reports which packets the UE failed to receive such that the NE may recover the packet.

Additionally, or alternatively, the NE 1100 may be configured to support where the second DCI includes an NDI associated with the second data block. This aspect ensures efficiency and limits resource and signaling overhead as the UE is able to detect the transmission of the second data block from received DCI instead of another separate indication.

Additionally, or alternatively, the NE 1100 may be configured to support where the report is received via a MAC-CE, where the MAC-CE includes a respective report for each HARQ process for which transmission of a respective second data block is detected. This aspect ensures efficiency and simplicity by employing existing capabilities of MAC-CEs for transmission of the retransmission request.

Additionally, or alternatively, the NE 1100 may be configured to support where, for each HARQ process included in the MAC-CE, the MAC-CE includes a TB field indicating for which TB of a plurality of TBs a report applies. This aspect ensures efficiency and simplicity by employing existing capabilities of MAC-CEs for transmission of the retransmission request.

Additionally, or alternatively, the NE 1100 may be configured to support where the report is received via an uplink channel, where the report includes one or more of HARQ feedback for the transmission of the second data block, HARQ feedback for the transmission of the first data block or an indication of the erroneous reception of the first data block. This aspect ensures resource and signaling efficiency by combining the report and HARQ feedback in a same transmission.

Additionally, or alternatively, the NE 1100 may be configured to support transmitting a message indicating a new HARQ process ID to which a UE is to move HARQ buffer content associated with the first data block, where the report includes one or more of an indication that the HARQ buffer content is moved to the HARQ. This aspect ensures resource and signaling efficiency by combining the report and HARQ feedback in a same transmission.

Additionally, or alternatively, the NE 1100 may be configured to support where the report includes an NDI value that is used for a continued transmission of the first data block using the new HARQ process ID to which the HARQ buffer content is moved. This aspect ensures the transmitted report is associated with the correct data block transmission. Additionally, or alternatively, the NE 1100 may be configured to support transmitting a configuration that enables or disables moving the HARQ buffer content to the new HARQ process ID. This aspect improves efficiency by ensuring the UE and the NE are aware of the use of the new HARQ process ID.

Additionally, or alternatively, the NE 1100 may support at least one memory (e.g., the memory 1104) and at least one processor (e.g., the processor 1102) coupled with the at least one memory and configured to cause the NE to transmit first DCI indicating a transmission of a first data block using a HARQ process; transmit second DCI indicating a transmission of a second data block using the HARQ process; and receive a report in response to the transmission of the first data block and the transmission of the second data block. In this manner, the NE 1100 supports reporting based on data block transmissions for a HARQ process, which improves efficiency, reduces latency, and reduces data loss as an NE is quickly informed of potential packet loss.

Additionally, or alternatively, the NE 1100 may be configured to support any one or combination of the following. For example, the NE 1100 may be configured to support where the report includes one or more of: a HARQ process ID corresponding to the HARQ process associated with the transmissions of the first data block and the second data block; an NDI associated with the second data block; an NDI associated with the first data block; an RV of a last-received transmission of the first data block; an ID associated with the first data block, where the ID is an SN, an RLC SDU ID, or an LCH ID; or a time of the transmission of the first data block. This aspect ensures that the UE accurately and efficiently reports which packets the UE failed to receive such that the NE may recover the packet.

Additionally, or alternatively, the NE 1100 may be configured to support where the second DCI includes an NDI associated with the second data block. This aspect ensures efficiency and limits resource and signaling overhead as the UE is able to detect the transmission of the second data block from received DCI instead of another separate indication.

Additionally, or alternatively, the NE 1100 may be configured to support where the report is received via a MAC-CE, where the MAC-CE includes a respective report for each HARQ process for which transmission of a respective second data block is detected. This aspect ensures efficiency and simplicity by employing existing capabilities of MAC-CEs for transmission of the retransmission request.

Additionally, or alternatively, the NE 1100 may be configured to support where, for each HARQ process included in the MAC-CE, the MAC-CE includes a TB field indicating for which TB of a plurality of TBs a report applies. This aspect ensures efficiency and simplicity by employing existing capabilities of MAC-CEs for transmission of the retransmission request.

Additionally, or alternatively, the NE 1100 may be configured to support where the report is received via an uplink channel, where the report includes one or more of HARQ feedback for the transmission of the second data block, HARQ feedback for the transmission of the first data block or an indication of the erroneous reception of the first data block. This aspect ensures resource and signaling efficiency by combining the report and HARQ feedback in a same transmission.

Additionally, or alternatively, the NE 1100 may be configured to support transmitting a message indicating a new HARQ process ID to which a UE is to move HARQ buffer content associated with the first data block, where the report includes one or more of an indication that the HARQ buffer content is moved to the HARQ. This aspect ensures resource and signaling efficiency by combining the report and HARQ feedback in a same transmission.

Additionally, or alternatively, the NE 1100 may be configured to support where the report includes an NDI value that is used for a continued transmission of the first data block using the new HARQ process ID to which the HARQ buffer content is moved. This aspect ensures the transmitted report is associated with the correct data block transmission. Additionally, or alternatively, the NE 1100 may be configured to support transmitting a configuration that enables or disables moving the HARQ buffer content to the new HARQ process ID. This aspect improves efficiency by ensuring the UE and the NE are aware of the use of the new HARQ process ID.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

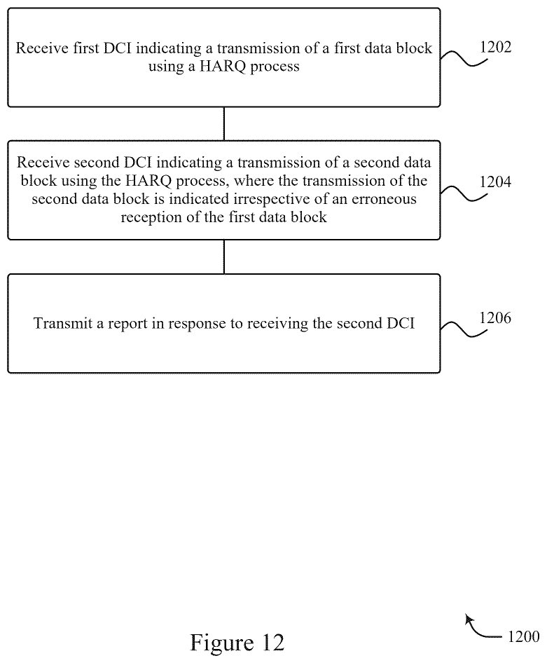

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include receiving first DCI indicating a transmission of a first data block using a HARQ process. The operations of 1202 may be performed in accordance with examples as described herein. In some implementations, aspects of the operations of 1202 may be performed by a UE as described with reference to FIG. 9.

At 1204, the method may include receiving second DCI indicating a transmission of a second data block using the HARQ process, where the transmission of the second data block is indicated irrespective of an erroneous reception of the first data block. The operations of 1204 may be performed in accordance with examples as described herein. In some implementations, aspects of the operations of 1204 may be performed by a UE as described with reference to FIG. 9.

At 1206, the method may include transmitting a report in response to receiving the second DCI. The operations of 1204 may be performed in accordance with examples as described herein. In some implementations, aspects of the operations of 1204 may be performed by a UE as described with reference to FIG. 9.

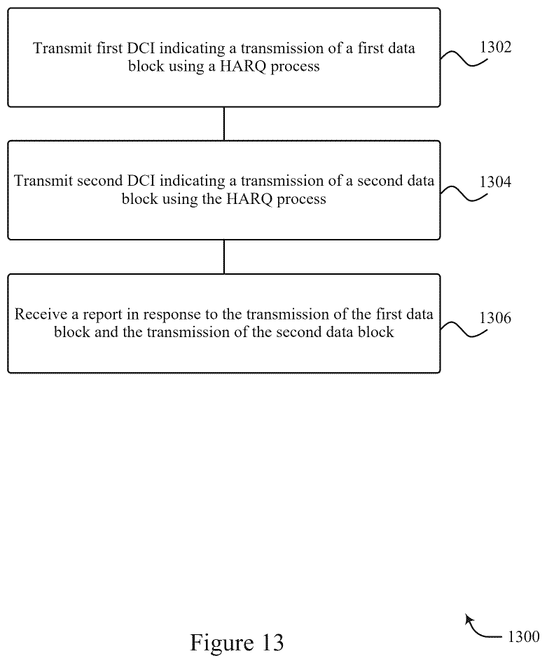

FIG. 13 illustrates a flowchart of a method 1300 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1302, the method may include transmitting first DCI indicating a transmission of a first data block using a HARQ process. The operations of 1302 may be performed in accordance with examples as described herein. In some implementations, aspects of the operations of 1302 may be performed by an NE as described with reference to FIG. 11.

At 1304, the method may include transmitting second DCI indicating a transmission of a second data block using the HARQ process. The operations of 1304 may be performed in accordance with examples as described herein. In some implementations, aspects of the operations of 1304 may be performed by an NE as described with reference to FIG. 11.

At 1306, the method may include receiving a report in response to the transmission of the first data block and the transmission of the second data block. The operations of 1304 may be performed in accordance with examples as described herein. In some implementations, aspects of the operations of 1304 may be performed by an NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive first downlink control information (DCI) indicating a transmission of a first data block using a hybrid automatic repeat request (HARQ) process;
receive second DCI indicating a transmission of a second data block using the HARQ process, wherein the transmission of the second data block is indicated irrespective of an erroneous reception of the first data block; and
transmit a report in response to receiving the second DCI.

2. The UE of claim 1, wherein the report comprises one or more of:
a HARQ process identifier (ID) corresponding to the HARQ process associated with the transmissions of the first data block and the second data block;
a new data indicator (NDI) associated with the second data block;
an NDI associated with the first data block;
a redundancy version (RV) of a last-received transmission of the first data block;
an ID associated with the first data block, wherein the ID is a sequence number (SN), a radio link control (RLC) service data unit (SDU) ID, or a logical channel (LCH) ID; or
a time of the transmission of the first data block.

3. The UE of claim 1, wherein the second DCI includes a new data indicator (NDI) associated with the second data block, and wherein the at least one processor is further operable to cause the UE to detect the transmission of the second data block based at least in part on the NDI.

4. The UE of claim 1, wherein the at least one processor is further operable to cause the UE to determine the erroneous reception of the first data block based at least in part on an error detection code associated with the first data block.

5. The UE of claim 1, wherein the report is transmitted based at least in part on a HARQ buffer associated with the HARQ process being flushed.

6. The UE of claim 1, wherein the report is transmitted via a medium access control (MAC)-control element (MAC-CE), wherein the MAC-CE includes a respective report for each HARQ process for which transmission of a respective second data block is detected.

7. The UE of claim 6, wherein, for each HARQ process included in the MAC-CE, the MAC-CE includes a transport block (TB) field indicating for which TB of a plurality of TBs a report applies.

8. The UE of claim 1, wherein the report is transmitted via an uplink channel, wherein the report comprises one or more of HARQ feedback for the transmission of the second data block, HARQ feedback for the transmission of the first data block or an indication of the erroneous reception of the first data block.

9. The UE of claim 1, wherein the at least one processor is further operable to cause the UE to receive a message indicating a new HARQ process identifier (ID) to which the UE is to move HARQ buffer content associated with the first data block, wherein the report includes one or more of an indication that the HARQ buffer content is moved to the new HARQ process ID, an indication of the new HARQ process ID.

10. The UE of claim 9, wherein the report includes a new data indicator (NDI) value that is used for a continued transmission of the first data block using the new HARQ process ID to which the HARQ buffer content is moved.

11. The UE of claim 9, wherein the at least one processor is further operable to cause the UE to receive a configuration that enables or disables moving the HARQ buffer content to the new HARQ process ID.

12. A network equipment (NE) for wireless communication, comprising:
at least one memory; and
at least one processor coupled with the at least one memory and operable to cause the NE to:
transmit first downlink control information (DCI) indicating a transmission of a first data block using a hybrid automatic repeat request (HARQ) process;
transmit second DCI indicating a transmission of a second data block using the HARQ process; and
receive a report in response to the transmission of the first data block and the transmission of the second data block.

13. The NE of claim 12, wherein the report comprises one or more of:
a HARQ process identifier (ID) corresponding to the HARQ process associated with the transmissions of the first data block and the second data block;
a new data indicator (NDI) associated with the second data block;
an NDI associated with the first data block;
a redundancy version (RV) of a last-received transmission of the first data block;
an ID associated with the first data block, wherein the ID is a sequence number (SN), a radio link control (RLC) service data unit (SDU) ID, or a logical channel (LCH) ID; or
a time of the transmission of the first data block.

14. The NE of claim 12, wherein the report is received via a medium access control (MAC)-control element (MAC-CE), wherein the MAC-CE includes a respective report for each HARQ process for which transmission of a respective second data block is detected.

15. The NE of claim 14, wherein, for each HARQ process included in the MAC-CE, the MAC-CE includes a transport block (TB) field indicating for which TB of a plurality of TBs a report applies.

16. The NE of claim 12, wherein the report is received via an uplink channel, wherein the report comprises one or more of HARQ feedback for the transmission of the second data block, HARQ feedback for the transmission of the first data block or an indication of an erroneous reception of the first data block.

17. The NE of claim 12, wherein the at least one processor is further operable to cause the NE to transmit a message indicating a new HARQ process identifier (ID) to which a user equipment (UE) is to move HARQ buffer content associated with the first data block, wherein the report includes one or more of an indication that the HARQ buffer content is moved to the HARQ process ID, an indication of the HARQ process ID.

18. The NE of claim 17, wherein the report includes a new data indicator (NDI) value that is used for a continued transmission of the first data block using the new HARQ process ID to which the HARQ buffer content is moved.

19. A method performed by a user equipment (UE), the method comprising:
receiving first downlink control information (DCI) indicating a transmission of a first data block using a hybrid automatic repeat request (HARQ) process;
receiving second DCI indicating a transmission of a second data block using the HARQ process, wherein the transmission of the second data block is indicated irrespective of an erroneous reception of the first data block; and
transmitting a report in response to receiving the second DCI.

20. A method performed by a network equipment (NE), the method comprising:
transmitting first downlink control information (DCI) indicating a transmission of a first data block using a hybrid automatic repeat request (HARQ) process;
transmitting second DCI indicating a transmission of a second data block using the HARQ process; and
receiving a report in response to the transmission of the first data block and the transmission of the second data block.
